(19) United States
(12) Patent Application Publication
(10) Pub. No.: US 2006/0223042 A1
(43) Pub. Date: Oct. 5, 2006

(54) Voice activated decision support

(75) Inventors: John E. Epler, Evanston, IL (US); Michael J. Vanrooyen, Wayland, MA (US); Eric R. Spencer, Chicago, IL (US); Ron Elfenbein, Annapolis, MD (US)

Correspondence Address: MCANDREWS HELD & MALLOY, LTD, 500 WEST MADISON STREET, SUITE 3400, CHICAGO, IL, 60661, US

(73) Assignee: PICIS, Inc.

(21) Appl. No.: 11/131,866

(22) Filed: May 18, 2005

Related U.S. Application Data
(60) Provisional application No. 60/667,156, filed on Mar. 30, 2005.

(51) Int. Cl. G09B 7/00

(52) U.S. Cl. 434/323

(57) ABSTRACT

A coaching device and method for providing emergency medical care instructions is shown. The device can include a memory, an audio input, an audio output, a visual display, and a processor. The memory stores a file set made up of multiple question files. The question files include audio data representing a spoken question, at least one valid answer proposed for the question, and visual material. The visual material can be a text version of the question or a valid answer or a visual illustration of the subject matter of the question. Each question file is linked with at least one other question file. A program manages the question files by playing a question, detecting a spoken valid answer to the spoken question, and loading another question file linked to the detected answer. The modular set of interrelated questions provides the rescuer with highly interactive instructions.

### CROSS-REFERENCE RELATED APPLICATIONS

Priority is claimed from provisional application U.S. Ser. No. ______, filed Mar. 30, 2005, Attorney Docket No. 15835US01. The entire specification and all the claims of the provisional application referred to above are hereby incorporated by reference to provide continuity of disclosure. All of provisional patent application Ser. No. 60/461,634, filed Apr. 9, 2003, addressing similar subject matter, is incorporated by reference here.

### GOVERNMENT CONTRACT RIGHTS

The government has rights under NASA contract NAS2-03101.

### BACKGROUND

The present invention relates to apparatus and a method to coach an individual to effectively assist a person who has a medical emergency (referred to here broadly as a “patient,” even if the assisting person is not a medical professional). One application of the invention is to provide a higher level of medical assistance than has previously been available to individuals who are out of reach of conventional medical care, such as astronauts on a space mission.

People crewing spacecraft, ships at sea, land expeditions, offshore oil platforms, and other ventures that operate remotely from conventional medical facilities for substantial periods have a need for medical care as medical emergencies arise. Since many such ventures are not adequately staffed with medical professionals, the care of participants often has been substandard. Other participants in such ventures have been forced to attempt medical care beyond what they are trained or able to do.

First aid instructions have been provided for use by non-medically-trained individuals generally, covering common emergency situations. In some situations, situation-specific first aid instructions have been publicized. One example is a poster, found in many food service environments, showing employees how to perform the Heimlich maneuver to rescue a choking person. Such instructions have either been very limited in scope, such as the Heimlich maneuver poster, or more complicated to cover more situations.

Where the instructions are more complicated, as in a first aid manual, it has been necessary to extensively train the rescuer in advance of an emergency situation, as in a classroom, what actions must be taken very quickly to prevent deterioration of the condition of the patient. This training must be refreshed periodically. Without current training, a rescuer attempting to help the patient would require too much time to find and learn the appropriate steps to take to help the patient, and may do more harm than good.

On the other hand, checklists and instruction manuals for medical professionals, in text and flow chart form, have long been published on paper to assist a rescuer in rendering emergency assistance to a patient suffering from a variety of maladies, such as cessation of breathing. Such instruction manuals include the Advanced Cardiac Life Support (ACLS) guidelines published by the American Heart Association. Such tools have not been suitable for use by a person who is not trained as a physician.

In a populated environment where paramedics are on call and able to swiftly reach a patient, the need for detailed coaching for non-medically-trained individuals is less severe, although some hazards like rapid bleeding, a heart attack or other cardiovascular failure, and obstruction of an airway have necessitated first aid training of non-medically-trained individuals even when professional help can be quickly obtained. But in remote areas where paramedics cannot reach the patient in a few minutes, the number of situations requiring detailed knowledge of a helper increases. In such situations, help cannot merely be administered for a few minutes until professional caregivers arrive. The help provided by an amateur on the scene may be the only care the patient will receive.

One example of an environment calling for more help to a non-professional caregiver is space habitation and travel, as in the Space Shuttle, a space station, or on a mission to another planet. Astronauts are trained to have a high degree of self-sufficiency, but crew size is severely constrained by the payload limits of spacecraft. A space crew cannot necessarily afford to have a trained medical professional on board, as medical knowledge is only one of many necessary skill sets needed and only a few crew members travel together. Moreover, even a fully trained medical professional would be underutilized on such a trip, and would lose competency over time.

Still further, while earthbound physicians could be consulted by radio in some instances to provide coaching, spacecraft are sometimes unable to communicate with an Earth station for extended periods. On interplanetary journeys in particular, the communication delay resulting from the distance between the spacecraft and Earth may make effective coaching difficult or impossible, particularly where quick action is necessary. Even closer spacecraft and terrestrial venturers may have difficulty communicating by radio or relay satellite under some atmospheric conditions. As another example, submerged submarines have limited avenues for communication, and if on a military mission requiring the location of the submarine to be unknown the submarine may have no effective communication option with medical facilities of any kind. Underground mines also present difficulties in communication, due to the difficulty of transmitting radio waves through underground formations.

The abstract of U.S. Pat. No. 5,913,685 discusses “a cardiopulmonary resuscitation (CPR) aiding computer system,” said to “provide guidance to rescue personnel trained in CPR for resuscitating a victim under an emergency condition. The system includes an input for entering information signals representative at least of characteristics of the victim relevant to proper performance of CPR techniques, a processing unit responsive to the information signals and for providing output signals representative of proper steps to be taken in resuscitating the victim, and an output, including a display, responsive to the output signals and for providing guidance signals, which include visible signals, such as animated images, on the display, of the proper steps to be taken by the rescue personnel in resuscitating the victim. In one embodiment, the output includes an audio system for producing audible guidance in response to the output signals, wherein the speech guidance is synchronized with the visible guidance. The system can be configured as a personal computer, or as a network of terminals and computers.”

See for example FIGS. 1 and 4A of the '685 patent, showing some details of such a system. The patent states at col. 1, lines 42-51: “The computer terminal broadcasts audible and visible signals to allow rescuers full use of hands, eyes, voice, mouth, and body while being guided through a rescue with the proper timing for each resuscitation step. Rescue personnel can enter into an input of the computer terminal information signals representative at least of characteristics of a victim relevant to proper performance of CPR techniques. The information signals can indicate the age group of the victim, the number of rescuers present, and a selected CPR procedure.”

The patent states at col. 6, lines 53-67: “In a windows type of operating system having a CPR aiding icon displayed on the video display 24, the rescuer may initiate the CPR aiding program by clicking on the icon with mouse 34, touching the icon if the system has a touch screen 36, by pointing to the icon with pointer 38, or the like. Or, in another embodiment, the rescuer can initiate the program by a vocal command to microphone 30, which is communicated to CPU 12 through voice recognition device 40. *** Depending upon the actual configuration of the computer system 10, the mouse 34, pointer 38 and microphone 30 can also be used for entering information.”

The '685 patent describes a system that is not interactive, as it does not adapt to changes in condition of the patient during performance of the procedure. It merely allows the rescuer to select which procedure to be followed by a few instructions at the beginning identifying the age of the victim, the number of rescuers, and whether the victim appears to be breathing or not, choking or not, and conscious or not. See col. 8, lines 10-19. Once a routine is selected, it is apparently played through from beginning to end, without regard to changes in the condition of the patient during the rescue.

See also U.S. Published Application Nos. US 2002/0052540 A1 and US 2002/0078966 A1 and U.S. Pat. Nos. 6,356,785; 5,857,966; 5,394,892; 5,341,291; 5,088,037; and 4,588,383. Each of these documents has one or more of the following disadvantages or limitations:
Does not disclose a hands-free device
Is not adapted for operation by a non-medical person.
Does not address the specific problem of how to manage an airway obstruction
Is not adapted for remote operation, where routine laboratory tests and other hospital services assisting a diagnosis and treatment are not available
Does not receive and process voice responses from the user.

All of the documents referred to in this specification are incorporated here by reference for their relevant disclosure.

There is a need for an improved portable, self-contained medical assist device that can be deployed and utilized in spacecraft and other comparable situations. The primary driving force for this initiative is to provide for a higher degree of autonomy for astronaut crews in order that they might provide “standard of care” emergency first-aid. Such a device would also be useful in other environments where a small group of people are together in a remote location where telecommunication is difficult and no other medical help is available in the short term, such as hard rock mining, offshore oil platforms, ships at sea, planes flying overseas, backpackers, etc.

Such a device would also be desirable to train new medical professionals, providing a high level of coaching when they begin learning their profession.

### SUMMARY

One aspect of the invention is a coaching device useful for providing emergency medical care instructions to a relatively untrained user. The coaching device can include an addressable memory, an audio input, an audio output, a visual display, and a computer processor. The computer processor is connected to the memory, audio input, audio output, and visual display.

The memory stores a file set made up of multiple question files. The question files include audio data representing a spoken question, at least one valid answer proposed for the question, and visual material. The visual material can be a text version of the question, a text version of a valid answer, a visual illustration of the subject matter of the question, or a combination of these.

Each question file defined here has a link with at least one other question file. The linked question files are related as a prior question and a subsequent question. The link associates the subsequent question with a valid answer given to the prior question.

A program is stored in the memory to manage the question files. The program is adapted to cause the processor to load a question file, direct an audio signal associated with the question file to the audio outlet to speak an audible question, direct a display signal associated with the question file to the display to provide an illustration pertinent to the spoken question on the display, detect a spoken valid answer to the spoken question in the audio input, and load another question file linked to the detected answer.

Another aspect of the invention is an electronically implemented coaching method useful for providing emergency medical care instructions to a relatively untrained user.

One step of the method is providing a multiplicity of question files containing audio data representing a spoken question, and at least one valid answer proposed for the question. The question files also include visual material that may be, for example, a text version of the question, a text version of a valid answer, a visual illustration of the subject matter of the question, or a combination of these.

Additional steps of the method include loading a question file in a processor, asking a spoken question by playing an audio file of the question, and directing a display signal associated with the question file to the display to provide an illustration pertinent to the spoken question on the display.

Other steps of the method include detecting a spoken valid answer to the spoken question, and loading another question file linked to the detected answer.

In a preferred embodiment, the interrelations between the respective question files provide interaction between the rescuer and the device at multiple stages during a rescue, in particular an extended rescue with multiple steps. Thus, the rescue desirably is well tailored to the condition of the patient as it develops during the rescue.

### BRIEF DESCRIPTION OF DRAWING FIGURES

FIG. 1 is a perspective view of one embodiment of the voice-activated decision support module.

FIG. 2 is a schematic view of the module.

FIG. 3 is a flow chart showing a basic algorithm useful for operating a voice activated decision support system.

FIG. 4 is a screen shot of a visual and text presentation of medical assistance information to allow evaluation whether a patient has a carotid pulse.

FIG. 5 is a screen shot of a visual and text presentation of medical assistance information instructing the rescuer in the performance of CPR.

FIGS. 6a and 6b are a flow chart in two parts of an emergency treatment algorithm for an airway emergency, for use in accordance with the present invention.

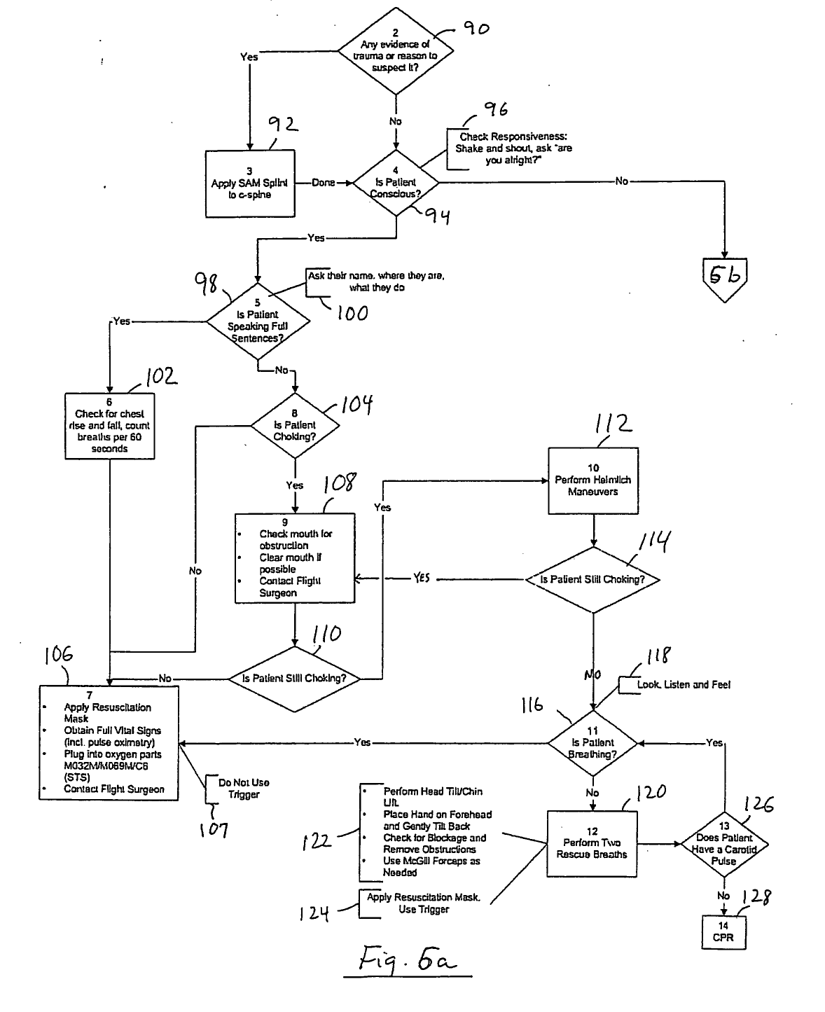

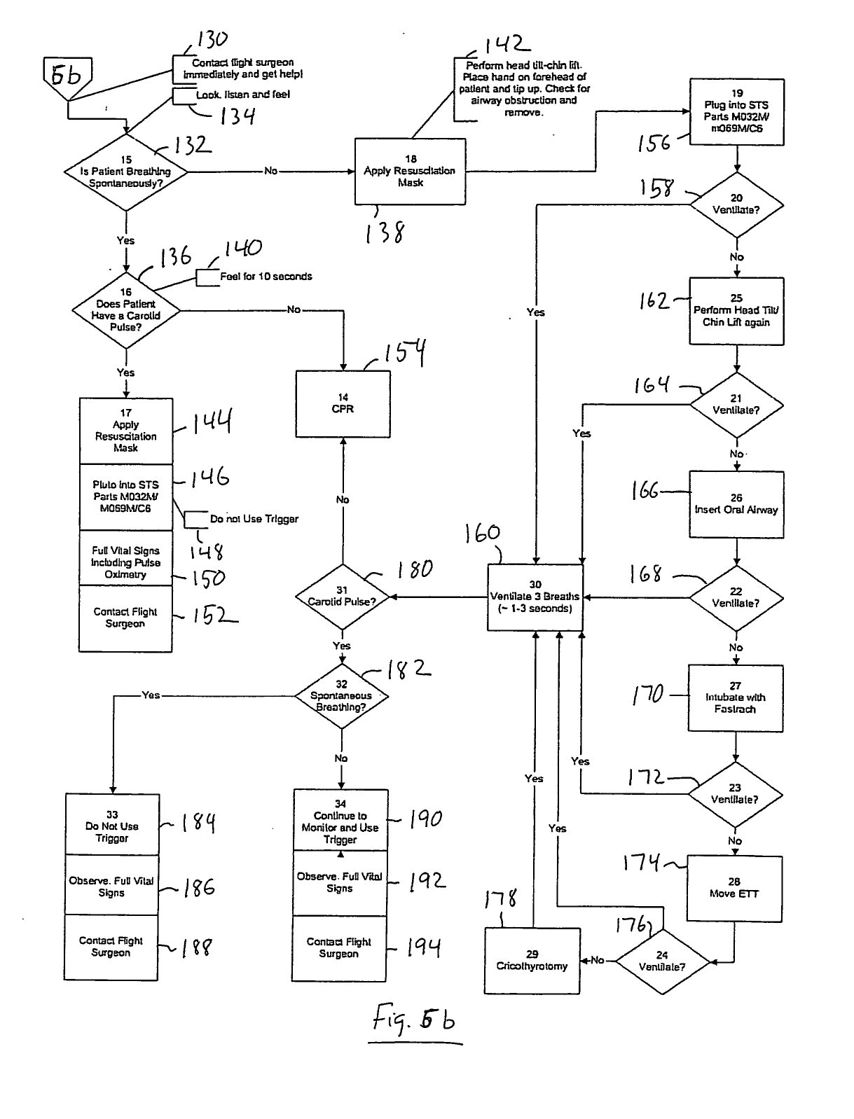

The following reference characters are used in the drawing figures.
20 voice activated decision support module
22 CPU
24 memory
26 microphone
28 pointing device
30 display
32 speaker
34 battery
36 switch (on-off)
38 speaker grille
40 microphone port
42 housing
44 charger
50 initialize step
52 load step
54 oral presentation step
56 visual presentation step
58 listening step
60 receiving answer step
62 file selection step
64 repeat question step
66 algorithm
70 first question
72 text of question
74 valid answers
76 illustration
78 second question
90 question (FIG. 6a)
92 instruction (FIG. 6a)
94 question (FIG. 6a)
96 instruction (FIG. 6a)
98 question (FIG. 6a)
100 instruction (FIG. 6a)
102 instruction (FIG. 6a)
104 question (FIG. 6a)
106 instruction (FIG. 6a)
107 instruction (FIG. 6a)
108 instruction (FIG. 6a)
110 question (FIG. 6a)
112 instruction (FIG. 6a)
114 question (FIG. 6a)
116 question (FIG. 6a)
118 instruction (FIG. 6a)
120 instruction (FIG. 6a)
122 instruction (FIG. 6a)
124 instruction (FIG. 6a)
126 question (FIG. 6a)
128 instruction (FIG. 6a)
130 instruction (FIG. 6b)
132 question (FIG. 6b)
134 instruction (FIG. 6b)
136 question (FIG. 6b)
138 instruction (FIG. 6b)
140 instruction (FIG. 6b)
142 instruction (FIG. 6b)
144 instruction (FIG. 6b)
146 instruction (FIG. 6b)
148 instruction (FIG. 6b)
150 instruction (FIG. 6b)
152 instruction (FIG. 6b)
154 instruction (FIG. 6b)
156 instruction (FIG. 6b)
158 question (FIG. 6b)
160 instruction (FIG. 6b)
162 instruction (FIG. 6b)
164 question (FIG. 6b)
166 instruction (FIG. 6b)
168 question (FIG. 6b)
170 instruction (FIG. 6b)
172 question (FIG. 6b)
174 instruction (FIG. 6b)
176 question (FIG. 6b)
178 instruction (FIG. 6b)
180 question (FIG. 6b)
182 question (FIG. 6b)
184 instruction (FIG. 6b)
186 instruction (FIG. 6b)
188 instruction (FIG. 6b)
190 instruction (FIG. 6b)
192 instruction (FIG. 6b)
194 instruction (FIG. 6b)

### DETAILED DESCRIPTION

The scope of the invention is not limited to the one or more embodiments of the invention described in the specification, which are representative. The full scope of the present invention is defined by the claims.

The invention is a portable, hands-free device that can be used in a medical emergency in a remote location where no physician is available on site. The usual rescuer would be an untrained person who is available to assist the patient, although the invention is not limited to a device for use by untrained rescuers.

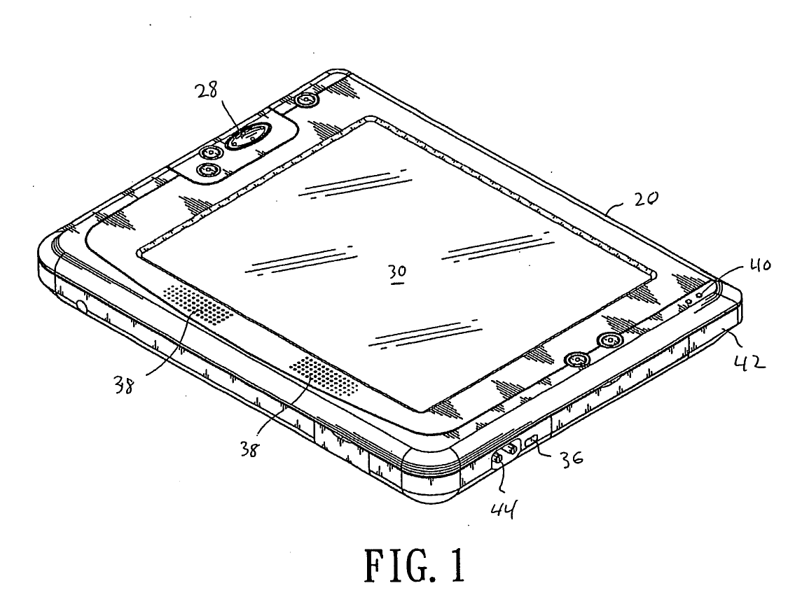

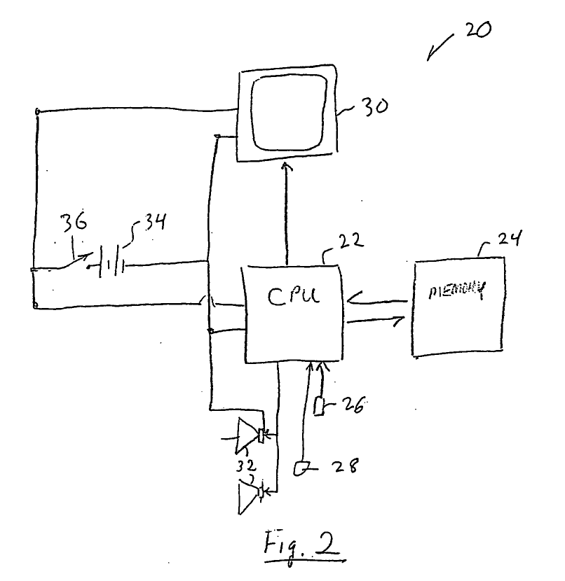

Referring to FIGS. 1 and 2, one embodiment of the invention is shown, configured as a tablet computer, though other configurations are also contemplated. The voice activated decision support module 20 generally includes a central processing unit 22, typically a microprocessor although processors of any size or type are contemplated, and a memory 24. The memory 24 may be a separate component or an integral part of the microprocessor 22. Examples of suitable memory media are compact discs, DVD's, RAM, ROM or programmable ROM solid-state memories, magnetic media such as a hard drive or a diskette, and other devices now known or later developed. The central processing unit or memory, even if expressed in the singular, may be a single device or more than one device.

In the illustrated embodiment, two input devices are provided: a microphone 26 and a pointing device 28. Referring to FIG. 1 in particular, the pointing device 28 is a two-way rocker switch that rocks in two perpendicular directions to move a cursor on the display 30. Any other pointing device can alternatively be used, such as a touch screen, touchpad, track ball, mouse, or other devices now known or later developed.

Two output devices are also provided in this embodiment: the display 30, which can be, for example, a liquid crystal display (LCD), and a pair of loudspeakers 32. Other types of displays, or even no display, can be provided, and other types of output devices can also be used.

One particularly contemplated embodiment involves the use, at least optionally, of a headset including a microphone and one or more speakers, to facilitate speech recognition by the module 20 and comprehension of instructions by the user in a noisy environment.

The module includes a battery 34 to power it and an on-off switch 36 to connect and disconnect the battery 34 from the components of the module 30 requiring power to operate.

The module 20 has recessed speakers 32 and a recessed microphone 26 (not shown in FIG. 1). Referring to FIG. 1, speaker grilles 38 and a microphone aperture 40 are provided to transmit sound from the speakers 32 and to the microphone 26 through the housing 42 of the module 20.

In the embodiment of FIG. 1, the housing 42 has a charger port 44, which can be connected to a source of electrical power to charge the battery 34 or directly power the module 20. The source of electrical power can be a conventional source such as a generator, a photocell, house power (as in a spacecraft), or others. In another contemplated embodiment, however, the battery is charged or fresh when the module 20 is assembled, and has enough reserve power to operate the device throughout the mission without being recharged or replaced. It is contemplated that the module will be used lightly, perhaps once or even never during a particular mission. The module 20 can also have an onboard battery that is maintained in a fully charged state by an external source of power, such as house power or a photocell array, and is only self-powered when the external source of power fails.

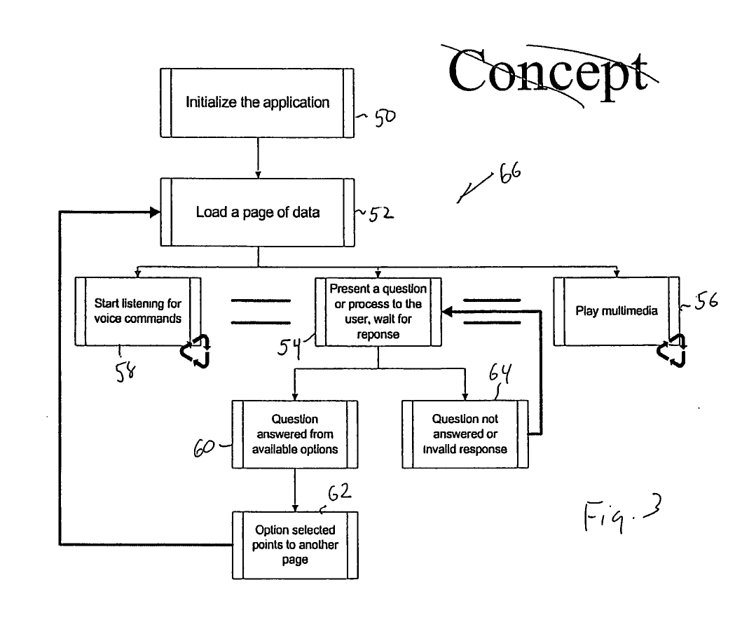

FIG. 3 shows the basic operation of the central processing unit 22 of the module 20. The module 20 presents a question, elicits an answer by the rescuer, and uses the answer to select the next question, until an appropriate concluding instruction is reached. Thus, the module 20 is extensively interactive, supports branching logic, and thus will present different questions depending on how the rescue is progressing.

“Question” as used in this specification is expressly defined to include a conventional question, usually indicated in text by a question mark and in speech by raising the pitch at the end of the statement, but also more broadly describes any statement that requires a response at some point, whether or not the statement is worded or stated as a question. For example, the instruction, “perform CPR,” accompanied by one or more valid responses the rescuer is expected to make, such as “explain,” “back,” “repeat,” “done,” or “home,” is defined as a question for purposes of the present specification.

In one embodiment, each question is stored in the memory 24 as a separate XML file, and is played when the answer to a previous question points to this question as the appropriate next question. “File” in the singular, as used herein, refers to a set of data used essentially simultaneously, whether formally stored in one computer file or in more than one computer file, or in the same memory or different memories, as when the data defining the spoken question is stored in one computer file in one memory and the data defining the accompanying visual presentation is stored in another computer file in another memory. In other words, if associated files function essentially like one file, they are included in the singular term “file.”

Referring to FIG. 3, in the step 50 the central processing unit is started and requested to begin presenting questions. In one embodiment, this step is carried out automatically when the switch 36 is closed to power up the module 20. This step may also be carried out responsive to a spoken command. In one embodiment, the necessary voice command to start the process can be printed permanently on or near the housing 42 in a prominent location, so it will be obvious how to start the module 20.

In the step 52 the CPU loads data from an XML file. When the application is first initialized, a predetermined first file can be loaded. This may be, for example, an index file that presents the list of emergencies the device is programmed to address and elicits from the rescuer an answer identifying the type of emergency to address. For example, the list of emergencies might be bleeding, choking, unconsciousness, or chest pain. This first file might also be permanently loaded in active memory, if necessary to save time when a rescue is started. Additionally, if the device is powered at least in part by external power, it can be maintained continuously in a booted-up condition, to provide an instant-on capability.

Once a pertinent file is loaded, in the step 54 the CPU orally presents to the rescuer the question represented by the file. This may be done by feeding the appropriate audio signal to the loudspeakers 32. At the same time, in the step 56, the CPU visually presents either the same question or background images or text on the display 30. The question requests the rescuer to speak, point to, or otherwise indicate the answer to the question being presented. Alternatively, the question could just be presented orally or just presented visually, although in the preferred embodiment both modes of communication are used to reinforce the communication. An appropriate first question might be, “State one: is the problem bleeding, choking, unconsciousness, or chest pain? This question and the selection of valid answers can also be presented on the display 30.

In the listening step 58, the CPU evaluates any signals received from the rescuer via the microphone 26, pointing device 28, or other input, in response to the question. In a preferred embodiment, the CPU is programmed to distinguish answers spoken by the rescuer from the audio feed to the speaker 34, which can be done using a signal cancellation circuit that identifies and subtracts the audio presented at the speaker 34 from the signal received by the microphone 26. This expedient reduces the chance that the CPU will be misled as to the correct answer by detecting an isolated word spoken from the loudspeaker, like “bleeding” in the above example, which is both part of the question and one of the valid answers.

In the preferred embodiment, the CPU is programmed to begin the listening step 58 at the same time the question is presented in the step 54, since, particularly by reading the visual presentation of the question in the step 56, the rescuer may determine and state the answer before the audio version of the question is completed. This expedient will allow the rescuer to speed up the process by answering one question and moving on to the next question as soon as possible.

The listening step 58 and the visual display step 56 can be programmed to run continuously while the question is being audibly presented in the step 54, so the rescuer can receive a visual input and answer the question even if the audible question is at first misunderstood or not heard.

The outcome of the listening step 58 determines what happens next. If a valid answer to the question is received (“valid” indicating that it is one of the possibilities contemplated, and not necessarily being a judgment whether the answer is correct or not), shown in FIG. 3 as option 60, the next question suggested by the response to the current question is selected at the step 62. Then the cycle repeats by loading the new question in the step 52, presenting the new question in the steps 54 and 56, listening for the answer to the new question in the step 58, etc.

If an invalid answer or no answer to the question is received, indicated by the step 64, in this embodiment the presentation step 54 is restarted, the visual presentation step 56 and the listening step 58 continue, and the module may optionally indicate to the rescuer, explicitly or by some type of signal, that the answer given was invalid and one of the stated alternatives should be selected. Or, the rescuer can be made aware that the module continues to present one question until a valid answer is received, at which time it immediately switches to the next question. Prompt feedback that no valid answer has been received gives the rescuer another opportunity to select a valid answer. The module can also be equipped to accept a manually entered answer, as when background noise prevents the speech recognition software from recognizing that a valid answer was given.

Another option that can be provided is to revert to the previous question if the current question receives no valid answer within a set number of repeats. For example, if the current question is not validly answered but the previous question was validly answered, it is possible that the previous question was answered incorrectly and thus led to an inappropriate follow-up question. This can be addressed either by directly loading and playing the previous question again, or by pointing to a new question, played in response to the basic question not being validly answered, stating that a valid answer has not been received, and asking whether the rescuer wants the device to stop (as when the emergency terminates before the end of the sequence), go back to the previous question, or explain the current question further. If the rescuer requests the module 20 to explain the current question further, the rescuer can be requested to state any word in the question that is unclear. The module 20 can then play a definition for any unclear word, which may also be accompanied by a further illustration on the display 30.

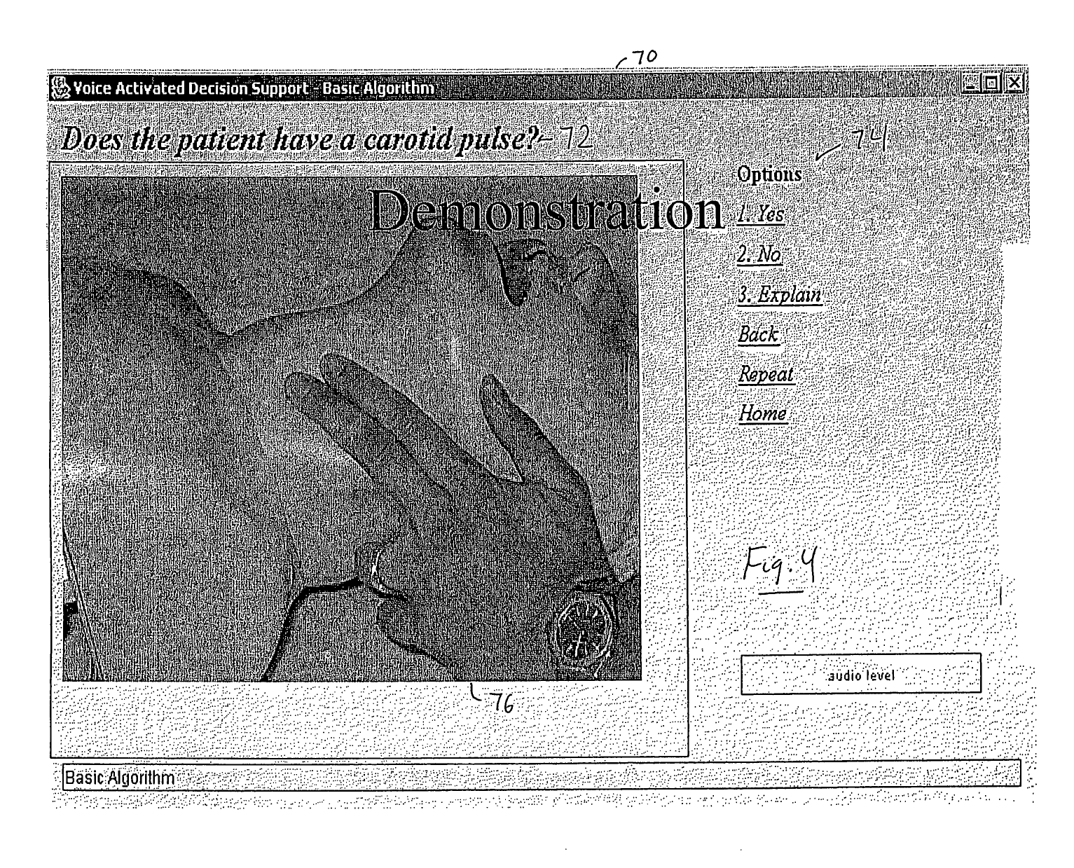

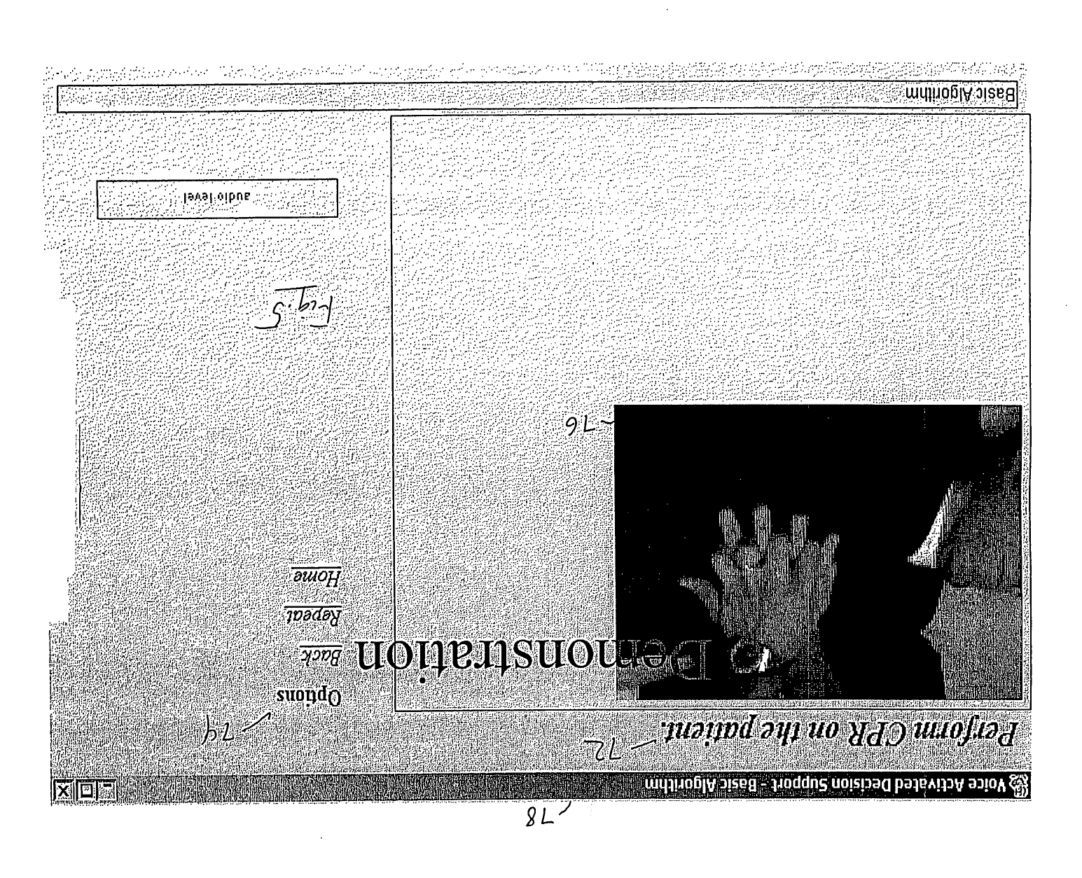

Examples of two suitable questions for one step of evaluation and one step of treatment of a patient who is not breathing are shown in FIGS. 4 and 5. These Figures show two successive screens of data presented on the visual display 30 for diagnosis and treatment of cessation of the patient's heartbeat, as may be necessary in the course of treating an unconscious choking patient after the cause of choking has been corrected.

In the screen 70 shown in FIG. 4, the text 72 of the question is shown in the display 30, and in the preferred embodiment the same question is also stated orally via the speakers 32. The selection 74 of valid answers is also displayed, as is an illustration 76 of the medical technique to be performed on the patient to enable the rescuer to answer the question—checking the carotid pulse of the patient. The selection of valid answers 74 preferably is comprehensive, so the rescuer will not be at a loss to either select a response that advances treatment or indicate that a further explanation or other corrective action is needed. The illustration 76 can either be a still photograph or illustration or a video or animation clip showing dynamically how the diagnostic step of checking the carotid artery is performed.

If the rescuer selects “NO” as the response to the question 72 in FIG. 4, the file linked to the answer “NO” presents the information shown in FIG. 5, including the question 78 (in this case a treatment step). The text 72 of this question is: “Perform CPR on the patient,” accompanied by a visual illustration 76 of how to perform CPR (cardiopulmonary resuscitation). This is appropriate because, if the patient has no detectable carotid pulse, the patient's heart apparently has stopped and needs to be resuscitated. The visual illustration 76 can be a video clip or animation showing how to perform CPR.

In the case of CPR, which needs to be performed at a certain repetition rate to be most effective, the illustration 76 in the question 78 desirably is a video clip showing CPR applied at the correct repetition rate. An audio presentation can also be played coaching the rescuer when to compress the patient's chest and when to administer mouth-to-mouth resuscitation, as the two techniques making up complete CPR are alternated. This may provide considerable assistance even to a rescuer who is already trained in CPR, as it refreshes and reinforces correct technique as it is performed. The rescuer, who may have an altered perception of time due to the emergency, will be correctly paced to provide the most effective treatment.

For the question 78 of FIG. 5, fewer valid answers 74 are provided because, in this particular rescue routine, performing CPR is the final step of any sequence including it. Thus there is no need to link this question to a subsequent question. The options are to go back to a previous question, repeat this one, or conclude the rescue by selecting “Home” or powering down the unit.

The simple algorithm 66 shown in FIG. 3 for file selection and presentation provides a very flexible architecture for the module 20. The algorithm 66 is contemplated to be useful to coach any step of a medical procedure that can be explained in words or pictures. The same architecture can also be used for non-medical uses, as for coaching any type of process supported by the data files stored in the memory 24.

If any step of the presentation is to be revised, the XML file for that step can be revised or replaced, and the links between that file and previous and subsequent files can be updated as needed. This modular embodiment minimizes the opportunities for bugs to be introduced in the software. The set of questions can be arranged in a flow chart; each question can represent one box of a flow chart, and lines connecting the boxes of the flow chart can represent the links among questions. The flow chart can be used to verify that the valid answers all lead to the appropriate next files.

Another advantage of this modular arrangement is that a particular question or procedure to be performed may have application at more than one stage of the rescue, or for treatment of more than one condition. For example, the question 70 can be repeated if, responsive to the question 76, CPR has been performed for an appropriate length of time, and the rescuer needs to determine whether the CPR was effective to restore a carotid pulse in the patient. Thus, files coaching a limited number of procedures can be combined in different ways to coach appropriate treatment for a wide variety of different situations.

An example of a flow chart showing the interrelation of questions and treatment steps for rescuing a choking patient on a Space Shuttle mission is shown in FIG. 6, which is presented in two parts as FIGS. 6a and 6b. Starting at the top of FIG. 6a, the first question 90 asks whether there is any evidence of trauma. If so, the rescuer is directed in the instruction 92 to apply a SAM splint to the patient's cervical spine. The splint is applied to prevent the treatment of the patient from aggravating a spinal cord injury. When done applying the splint, the rescuer indicates completion and continues to the question 94. If the answer to the question 90 is negative, the rescuer is directed straight to the question 94.

The question 94 asks the rescuer to determine whether the patient is conscious. The instruction 96 presented with the question 94 instructs the rescuer to check for consciousness by shaking the patient and shouting, “Are you all right?” If the patient is not conscious the next question is found in FIG. 5b, discussed further below.

If the patient is conscious, the next question, 98, is whether the patient is speaking full sentences. The detailed instruction 100 further adds that the answer to the question 98 can be found by asking the patient his or her name, where the patient is, or what the patient does. If the patient is conscious, according to the instruction 102, the patient's breathing rate is determined, oxygen is administered, and the flight surgeon is alerted according to the instruction 106, which is an endpoint of the procedure. (Despite the name, the “flight surgeon” is not a medical professional, and has limited training in surgery and other medical arts.) The instruction 106 tells the rescuer to apply a resuscitation mask, obtain full vital signs (including pulse oximetry), connect the resuscitator mask to a source of oxygen (resuscitation apparatus, identified by a part number), and contact the flight surgeon. The detailed instruction 107 tells the rescuer not to use the trigger on the resuscitation mask. The trigger is used, when needed, to mechanically ventilate the patient by periodically flowing air into the lungs and allowing it to flow back out, simulating normal breathing.

If the patient is not speaking full sentences, as queried in the question 98, the question 104 is asked: is the patient choking?

If the patient is choking, the instruction 108 is presented instructing the rescuer to check for and clear obstructions from the patient's mouth and notify the flight surgeon. The rescuer is then presented with the question 110: is the patient still choking? If yes, the instruction 112 is presented instructing the rescuer to perform the Heimlich maneuver. If no, the rescuer is referred to the instruction 106 as explained above.

Returning to the instruction 112, once the Heimlich maneuver has been performed, the rescuer is asked whether the patient is still choking. If so, the rescuer is returned to the instruction 108 as explained above. If not, the rescuer is presented with the question 116, asking whether the patient is breathing. The accompanying instruction to evaluate for breathing, 118, is to look at the patient for signs of breathing (chest movement), and listen and feel at the patient's mouth for passing air.

If breathing is detected, the rescuer is referred to instruction 106 as explained above. If no breathing is detected, the rescuer is referred to the instruction 120, “Perform two rescue breaths.” The more detailed instruction 122 for carrying out the general instruction 120 indicates that the rescuer should perform a head tilt/chin lift on the patient, place the rescuer's hand on the patient's forehead and gently tilt back, check the patient's mouth for blockage and remove obstructions, and “use McGill forceps as needed.” The more detailed instruction 124 for carrying out the general instruction 120 instructs the rescuer to “apply resuscitation mask” and “use trigger.” As before, the more detailed instructions can be presented as spoken instructions, displayed as text instructions, illustrated by figures or video clips, or presented by combining one or more of these media.

After the instruction 120 has been completed, the rescuer is presented with the question 126, asking whether the patient has a carotid pulse. Presentation of this question in text form with a pictorial illustration is also shown in FIG. 4. If the answer to question 126 is yes, the rescuer is referred back to the question 116 as previously discussed. If the answer given to question 126 is no, the rescuer is instructed by the instruction 128 to perform CPR. Presentation of this instruction in text form with a video clip illustration is also shown in FIG. 5. The step 128, if reached, is a final step in the procedure.

Returning now to the question 94, asking the rescuer whether the patient is conscious, if the answer is no, the rescuer is referred to continuation point 6b, shown at the top left of FIG. 6b.

Referring to the top left of FIG. 6b the rescuer next receives the instruction 130, “Contact flight surgeon immediately and get help.” When that has been done, the rescuer is presented the question 132, “Is patient breathing spontaneously?” If yes, the rescuer is asked the question 136; if no, the rescuer is referred to the instruction 138.

The question 136 is, “Does patient have a carotid pulse?” The rescuer is instructed to determine the answer to this question by the instruction 140, “feel for 10 seconds,” meaning that the rescuer should place a hand on the throat of the patient as shown in FIG. 4 for ten seconds. This instruction can again be illustrated by presenting FIG. 4 along with an audio instruction.

The instruction 138, reached if the patient has no carotid pulse, is “Apply resuscitation mask.” The instruction 138 is accompanied by the detailed instruction 142, “Perform head tilt-chin lift; Place hand on forehead of patient and tilt up; check for airway instruction and remove.”

If in answer to the question 136 the patient has a carotid pulse, the rescuer next receives the series of instructions 144-152, which are essentially the same as the instructions 106 and 107, except that the order of the oximetry step and the connecting to oxygen step are reversed. The instructions 144-152 are an endpoint of the procedure.

If in answer to the question 136 the patient has no carotid pulse, the rescuer next receives the instruction 154, “CPR,” which is the same as the instruction 128 and could be communicated by presenting the same data file in each case. The CPR instruction 154 is another endpoint of the rescue procedure.

Returning to the instructions 138 and 142, when the resuscitation mask has been applied, the rescuer is next instructed to connect the resuscitation mask to a source of oxygen, specifically a resuscitation unit called out by a part number (instruction 156). The question 158 is presented when the resuscitator is connected and working: “Ventilate?” In other words, is the resuscitator passing oxygen into and out of the patient's lungs? If yes, the rescuer is given the instruction 160: “Ventilate three breaths (1-3 seconds).” If no, the rescuer is given the instruction 162, “Perform head tilt/chin lift again,” followed by the question 164, “ventilate?” Since a demonstration of the “ventilate” instruction was given a few seconds before, a briefer visual or verbal demonstration can be given this time.

If ventilation is now reported, the rescuer is given the instruction 160 as explained above. If no ventilation is reported, the rescuer is given the instruction 166, “Insert oral airway.” After indicating insertion of the oral airway, another “Ventilate?” question 168 is given. Again, it may be appropriate to abbreviate this and any subsequent “Ventilate?” instruction. If ventilation is now reported, the rescuer is given the instruction 160 as explained above. If no ventilation is reported, the rescuer is given the instruction 170. The instruction 170 is “Intubate with Fastrach®,” which means the rescuer should place a Fastrach® endotrachial tube (ETT) in the patient to open up a new path for air. After the rescuer indicates insertion of the ETT, another “Ventilate?” question 172 is given. If ventilation is now reported, the rescuer is given the instruction 160 as explained above. If no ventilation is reported, the rescuer is given the instruction 174, “Move ETT.” After the rescuer indicates movement of the ETT, another “Ventilate?” question 176 is given. If ventilation is now reported, the rescuer is given the instruction 160 as explained above. If no ventilation is reported, the rescuer is given the instruction 178, “Crycothyrotomy,” another, more radical technique for opening a new airway, followed by the instruction 160 as explained above.

After the instruction 160 is carried out at any of the times indicated above, the rescuer is asked the question 180, “Carotid pulse?” This question may be presented similarly to the questions 126 and 136. If the answer is no, the rescuer is given the instruction 154, to perform CPR.

If the rescuer reports a carotid pulse, the rescuer is presented with the question 182, “Spontaneous breathing?” If spontaneous breathing is reported, the rescuer is given the instructions 184 (do not use trigger, i.e. do not mechanically ventilate the patient's lungs with the resuscitator), 186 (observe full vital signs), and 188 (contact flight surgeon), and this is an endpoint of the procedure. If no spontaneous breathing is reported, the rescuer is given the instructions 190 (continue to monitor and use trigger), 192 (observe full vital signs), and 194 (contact flight surgeon), and this is an endpoint of the procedure.

In the operation of one contemplated embodiment, the rescuer turns on the device or otherwise indicates that a medical emergency exists, then the device responds by asking questions, eliciting answers from the untrained person, asking follow-up questions as needed, then advising the untrained person how to proceed in view of the answers. The advice may be voice instructions and/or a visual display, such as an anatomical drawing or a video showing how to do a particular procedure on a patient, to assist the untrained rescuer.

Communication to and from the device is preferably by voice, at least in substantial part, so the untrained person has both hands free to assist as directed by the device.

The device can be adapted for use in remote locations where wired or wireless communication with outside resources is unreliable or unavailable, so the device preferably is self-contained.

The invention is portable, voice-activated, easy to program and use, and robust and stable in the healthcare environment. The device can contain thousands of algorithms in less than 10 pounds, as one example. The device can be adapted to be deployed in the space environment and can be appropriate for space travel. An advantage of the device is that it is able to ensure that the usual medical standard of care is met, while providing for a higher degree of autonomy to the layperson, and without the need to consult multiple pages in a manual or to receive extensive prior training.

As proposed, the device allows for easy input of new or revised instructions and is expandable to allow for multiple, complex algorithms that will allow for the replacement of existing, cumbersome paper or ordinary text file medical manuals. Rescuers do not need to spend much time updating their first aid skills, particularly to learn the order in which the procedures should be carried out in a given instance, yet they will be coached in the most up-to-date techniques. The primary need for updating is if a new procedure is added to the repertoire, in which case users can quickly develop a basic familiarity with the new procedure.

One embodiment of the invention uses IBM's ViaVoice® speech engine for data entry by conversion of spoken words to digital data having the same meaning. Additionally, standard pointing devices may be used. The application can be written in Java™, allowing its deployment in a wide variety of platforms. It allows for any algorithm to be added to the engine by writing simple XML documents. The application can handle multimedia presentations in addition to text prompts.

In one embodiment, the voice activated decision support presents the rescuer with a question or process audibly by using a sampled audio file. The software preferably is programmed to continue to repeat the question until a valid answer is given. While the delay time can be hard coded into the data for the page being displayed, this expedient may prove inadequate where the question or process is lengthy, particularly where questions or processes of different lengths are incorporated in the program. A hard-coded delay may in some instances expire before the question has been played back. This may result in the question being truncated or two parts of the same audio selection playing simultaneously. If the hard-coded delay is as long as the longest question or process, the program will take unduly long to go to the next question or process after a shorter question or process is run. By utilizing object-orientated programming methods, the audio playing thread can be programmed to notify the processor (and optionally the rescuer) that the audio has been completed.

The ability of the device to play various video multi-media feeds may also cause problems in timing for the repeat delay for the question. Again, using object oriented programming techniques, the video can be prevented from restarting before it finishes playing.

Voice activated decision support is a software application and content framework that can allow for the navigation, audible feedback, and browsing of decision trees which are represented by a series of inter-linking content documents. Normally, such decision trees can be represented at design time by a flowchart. The application will serve as a “coach,” prompting the rescuer with a question, listening for a response, then either asking another question, repeating the current question, or instructing the rescuer how to proceed, depending on what response is given.

Using the World Wide Web as a paradigm for inter-linking documents, one embodiment of the invention is a content-driven architecture composing of a root (or starting) document that recites one question, elicits an answer, and branches to one or more related documents, usually depending on the selected answer. All or most of the documents (possibly excepting the final document in a string, such as a document terminating the use of the device) have the capability to branch to other documents as well as recursion back to a previous location in the decision tree. Each document is called a “definition file” and is structured to contain various elements. The root definition can be structured like its child definitions except that it can be explicitly known to the application, can be used as a starting point, or can be returned to from anywhere within the tree navigation.

Several parameters can comprise a definition file. Exemplary parameters are as follows:
1. Name (variable length character). The parameter ‘Name’ is used to display title of the document in question.
2. Question (variable length character). The ‘Question’ parameter displays the text of the question that is given as a prompt to the rescuer. If other no pictures, video, etc. are available, the ‘Question’ parameter can reinforce communication of the question.
3. Question audio file (name of audio file). The ‘Question audio file’ is the filename of the audio that contains the sampled audio for the ‘Question’ parameter.
4. Question picture file (name of picture file). The ‘Question picture file’ is the filename of the picture that provides a visual cue for the ‘Question’ parameter.
5. Repeat question delay (unsigned integer). The ‘Repeat question delay’ is the number of seconds that should elapse before this ‘Question’ should be repeated. This parameter will be combined with a global delay parameter to get the actual number of seconds before repeating the question. A normal value for this parameter would be 0 (therefore using the global parameter).
6. Options (options field structure). A definition file can contain zero or more options that the rescuer can interact with in order to “browse” definition files. If there are zero options for a given definition file, then the file is considered to be a final result (end of a tree branch) for a given decision. This options field structure is defined below.

The options field structure can be used to describe the fields for use in a definition file as described above.
1. Title (variable length character). The parameter ‘Title’ is used to display the title of the document in question. It can be displayed in various ways. It can be hyper-linked as well to allow non-voice navigation.
2. ViaVoice® Grammar tag (variable length character). This character string directly maps to a ViaVoice® grammar rule that allows the IBM ViaVoice® speech recognition engine to decipher the spoken text for selecting the option.
3. Speech recognition phrase (variable length character). This is a word or phrase that will trigger the option. Only one of a ViaVoice® Grammar tag or a speech recognition phrase is required, in certain embodiments of the invention.
4. Definition file reference (filename of another definition file). This is the associate link to another definition file. Choosing this option will navigate to the ‘Definition file reference’ document.

This architecture is explicitly content driven. As such, the application has no inherent knowledge of the subject matter of the content. Potentially, any content can be identified, created, and included into the framework. In fact, multiple (possibly conceptually unrelated) decision support trees could be included within the same installation context. FIG. 3 gives a high level overview of the logic steps involved in navigating the content. Therefore, this software architecture can be utilized, optionally without modification, in any information context.

The use of hyperlinks and a web-like graphical interface lends itself to an ease of understanding and an intuitive learning model on the part of the rescuer utilizing the device.

Standard development methodologies can be utilized in the development of this technology. Java is one suitable development platform. IBM provides a Java SDK for the ViaVoice® runtime engine to provide integration with the ViaVoice® engine. Recent enhancements in version 1.4 of the Java development environment bring speed, stability, and a comprehensive toolset to the application. Java easily provides an environment where graphical applications (key to this framework) can be developed rapidly as compared to C/C++. The file format for the definition files can be XML. One suitable XML file program is exemplified as follows:

<?xml version=“1.0” ?>
− <vads version=“1”>
<title>Basic Algorithm</title>
<question>Is the patient speaking in full sentences?</question>
<audio>con_yes.wav</audio>
− <options>
− <option>
<name>Yes</name>
<grammar_name>yes</grammar_name>
<href>speak_yes.xml</href>
</option>
− <option>
<name>No</name>
<grammar_name>no</grammar_name>
<href>speak_no.xml</href>
</option>
− <option>
<name>Explain</name>
<grammar_name>explain</grammar_name>
<href>con_yes_explain.xml</href>
</option>
</options>
</vads>

Several adaptations of the present system are suitable to adapt the present device for successful implementation of this framework in the real world.

The computer hardware preferably can be small and lightweight, so it can easily be transported, both in the sense of adding little to the mission payload and in the sense of being portable within a spacecraft of substantial size. It can be ruggedly built to withstand the rigors of travel in the intended environment. The computer hardware preferably has a quality microphone built into the unit or available as an unobtrusive add-on. The computer hardware desirably has a built-in speaker capable of audio playback in a moderately noisy environment. The computer hardware's battery life preferably is sufficient to allow an hour of uninterrupted run time, if activated at the end of a journey of the scheduled length. In other words, the batteries preferably will retain a sufficient charge at the end of the journey to run the computer hardware for at least an hour.

A laptop compatible with Windows 2000 can be used, although implementation of the framework on handheld devices such as the Compaq® iPaq®, a tablet computer, or another lightweight, compact format is preferred. A dedicated device is preferred over a general-purpose computer, particularly to allow for instant starting without the usual booting up period required between powering up and using a general-purpose computer. The device should have at a minimum an audio input and output, so it can hear and deliver audio communications. In a preferred embodiment, the device also has a display so illustrations, the text of the audio message and answer options, or video clips can be displayed to reinforce or supplement the audio communication.

The present apparatus and method are readily adaptable to address other medical emergencies, such as wounds and wound care, bleeding, heat/cold injuries, shock, near-drowning and other forms of asphyxiation, electrical injuries, bio/chemical exposure, poisoning, orthopedic injuries (strains, sprains, fractures, dislocations), heart attacks, strokes, seizures, syncope, ophthalmic injuries or complaints, surgical emergencies such as appendicitis, cholecystitis, or hernias; envenomations; applications of bandages, casts, and splints; patient transfer protocols, and trauma assessments and management.

What is claimed is:

1. A coaching device useful for providing emergency medical care instructions to a relatively untrained user, comprising:
(A) an addressable memory;
(B) an audio input;
(C) an audio output;
(D) a visual display;
(E) a computer processor operatively interconnecting said memory, audio input, audio output, and visual display;
(F) a file set comprising multiple question files stored in the memory, the question files comprising audio data representing a spoken question, at least one valid answer proposed for the question, and visual material selected from
a text version of the question,
a text version of a valid answer,
a visual illustration of the subject matter of the question,
or a combination of these, and
each said question file having a link with at least one other said question file, the linked question files being related as a prior question and a subsequent question, and the link associating the subsequent question with a valid answer given to the prior question;
(G) a program stored in the memory adapted to cause the processor to:
load a question file,
direct an audio signal associated with the question file to the audio outlet to speak an audible question,
direct a display signal associated with the question file to the display to provide an illustration pertinent to the spoken question on the display;
detect a spoken valid answer to the spoken question in the audio input; and
load another question file linked to the detected answer.

2. The coaching device of claim 1, wherein said question file comprises data defining a plurality of the following parameters:
a name for the file;
the text of the question;
a question audio file to recite the question;
a question picture file to provide a visual illustration concerning the question; and
a repeat question delay.

3. The coaching device of claim 1, wherein said question file comprises data defining a name for the file and a question audio file to recite the question.

4. The coaching device of claim 3, wherein said question file further comprises data defining the text of the question.

5. The coaching device of claim 3, wherein said question file further comprises a question picture file to provide a visual illustration concerning the question.

6. The coaching device of claim 3, wherein said question file further comprises data defining a repeat question delay.

7. The coaching device of claim 3, wherein said processor further comprises a speech recognition engine and said question file further comprises a grammar tag that allows the speech recognition engine to decipher spoken text for selecting a linked file.

8. The coaching device of claim 3, wherein said question file further comprises data defining a speech recognition phrase that will trigger the selection of a linked file.

9. The coaching device of claim 3, wherein said question file further comprises data defining the link to another question file.

10. An electronically implemented coaching method useful for providing emergency medical care instructions to a relatively untrained user, comprising:
(A) providing a multiplicity of question files comprising audio data representing a spoken question, at least one valid answer proposed for the question, and visual material that is:
a text version of the question,
a text version of a valid answer,
a visual illustration of the subject matter of the question,
or a combination of these
(B) loading a question file in a processor;
(C) asking a spoken question by playing an audio file of the question;
(D) directing a display signal associated with the question file to the display to provide an illustration pertinent to the spoken question on the display;
(E) detecting a spoken valid answer to the spoken question; and
(F) loading another question file linked to the detected answer.
